(19) United States
(12) Patent Application Publication
(10) Pub. No.: US 2015/0220784 A1
(43) Pub. Date: Aug. 6, 2015

(54) METHOD AND SYSTEM FOR SEMI-AUTOMATED VENUE MONITORING

(71) Applicant: RF Spot Inc., Moffett Field, CA (US)

(72) Inventor: Andrew Joseph GOLD, Mountain View, CA (US)

(21) Appl. No.: 14/615,759

(22) Filed: Feb. 6, 2015

Related U.S. Application Data
(60) Provisional application No. 61/936,739, filed on Feb. 6, 2014.

(51) Int. Cl. G06K 9/00; G06K 9/66; G06K 9/62; G05D 1/02; B25J 9/16

(52) U.S. Cl. CPC G06K 9/00664; G05D 1/0246; B25J 9/1697; G06K 9/00442; G06K 9/6256; G06K 9/66

(57) ABSTRACT

A method is disclosed including capturing video data relating to a venue, processing the data to extract content therefrom and providing the video data and content via a communication network to a reviewer. The reviewer then reviews the video data and content and provides review results relating to an accuracy of the content. The review data is then relied upon to update the content.

### CROSS-REFERENCES TO RELATED APPLICATIONS

This application claims the benefit of U.S. Provisional Patent Application No. 61/936,739, filed Feb. 6, 2014, and incorporates the disclosure of the application by reference.

### FIELD OF INVENTION

The present invention relates to video monitoring of physical locations, and in particular to semi automated location management and review.

### SUMMARY OF THE EMBODIMENTS OF THE INVENTION

In accordance with the invention there is provided a method comprising capturing video data relating to a venue; providing the video data via a communication network to a reviewer, the reviewer for reviewing the video data; providing from the reviewer, review results relating to specific physical deficiencies at the venue to an input port of a system; transmitting from the system via the communication network to the venue data indicative of the physical deficiencies; correlating the deficiencies and known locations of the video images in which the deficiencies are identified with physical locations within the venue; and using data relating to a map of the venue, identifying deficiencies and their locations within the venue in a human intelligible form.

In accordance with the invention there is provided a method comprising capturing video data relating to a venue; capturing location data in association with the video data and for identifying a location of capture of the video data; providing the video data via a communication network to a server; retrieving the video data by a reviewer from the server, the reviewer for reviewing the video data; providing from the reviewer, review results relating to specific physical deficiencies at the venue to an input port of a system; transmitting from the system via the communication network to the venue data indicative of the physical deficiencies; correlating the deficiencies and known locations of the video images in which the deficiencies are identified with physical locations within the venue; and using data relating to a map of the venue, identifying deficiencies and their locations within the venue in a human intelligible form.

In accordance with the invention there is provided a method comprising capturing video data relating to a venue; capturing location data in association with the video data and for identifying a location of capture of the video data providing the video data via a communication network to a server; retrieving the video data by a reviewer from the server, the reviewer for reviewing the video data; providing from the reviewer, review results relating, to specific physical deficiencies at the venue to an input port of a system; transmitting from the system to the server via the communication network data indicative of the physical deficiencies; correlating the deficiencies and known locations of the video images in which the deficiencies are identified with physical locations within the venue; and using data relating to a map of the venue, identifying deficiencies and their locations within the venue in a human intelligible form.

In accordance with the invention there is provided a method comprising capturing sensor data relating to a venue; providing, the sensor data via a communication network to a reviewer, the reviewer for reviewing the sensor data; providing from the reviewer, review results relating to specific physical deficiencies at the venue to an input port of a system; transmitting from the system via the communication network to the venue data indicative of the physical deficiencies; correlating the deficiencies and known locations of the sensor data in which the deficiencies are identified with physical locations within the venue; and using data relating to a map of the venue, identifying deficiencies and their locations within the venue in a human intelligible form.

In accordance with the invention there is provided a method comprising capturing sensor data relating to a venue; capturing location data in association with the sensor data and for identifying a location of capture of the sensor data; providing the sensor data via a communication network to a server; retrieving the sensor data by a reviewer from the server, the reviewer for reviewing the sensor data; providing from the reviewer, review results relating to specific physical deficiencies at the venue to an input port of a system; transmitting from the system via the communication network to the venue data indicative of the physical deficiencies; correlating the deficiencies and known locations of the sensor images in which the deficiencies are identified with physical locations within the venue; and using data relating to a map of the venue, identifying deficiencies and their locations within the venue in a human intelligible form.

In accordance with the invention there is provided a method comprising capturing sensor data relating to a venue; capturing location data in association with the sensor data and for identifying a location of capture of the sensor data; providing the sensor data via a communication network to a server; retrieving the sensor data by a reviewer from the server, the reviewer for reviewing the sensor data; providing from the reviewer, review results relating to specific physical deficiencies at the venue to an input port of a system; transmitting from the system to the server via the communication network data indicative of the physical deficiencies; correlating the deficiencies and known locations of the sensor images in which the deficiencies are identified with physical locations within the venue; and using data relating to a map of the venue, identifying deficiencies and their locations within the venue in a human intelligible form.

### BRIEF DESCRIPTION OF THE DRAWINGS

Exemplary embodiments will now be described in conjunction with the following drawings, wherein like numerals refer to elements having similar function, in which:

FIG. 1 is a simplified block diagram of a robot having a plurality of sensors thereon.

FIG. 2 is a simplified block diagram of another robot having a plurality of sensors thereon.

FIG. 3 is a simplified block diagram of a communication system.

FIG. 4 is a simplified block diagram showing the interrelation between data according to an embodiment of the invention.

FIG. 5 is a simplified flow diagram of a method of semi-automatically tracking inventory according to an embodiment of the invention.

FIG. 6 is a simplified flow diagram of the steps taken once empty shelf spaces are correlated in the planogram with a product.

FIG. 7 is a simplified flow diagram of steps taken by an inventory reviewer according to an embodiment of the invention.

FIG. 8 is another simplified flow diagram of steps taken by an inventory reviewer according to an embodiment of the invention.

FIG. 9 is a simplified flow diagram of a method to recruit inventory reviewers for reviewing video data of a retail store.

FIG. 10 is a simplified flow diagram of a method to improve training and performance of an automated image processing method.

### DETAILED DESCRIPTION OF THE EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

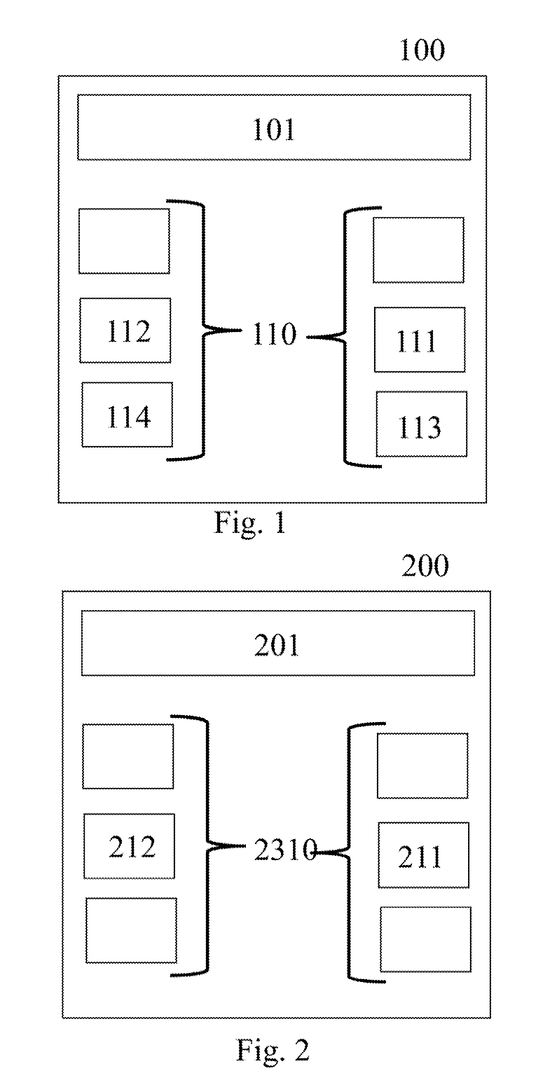

Referring to FIG. 1, shown is a robot 100 having a plurality of sensors thereon. The robot 100, has a positioning system 101 for determining, its location within a building. Robot 100 also has a plurality of sensors 110 for sensing its surroundings. For example, video camera 111 senses to the let of the robot 100 while video camera 112 senses to the right of the robot 100. As the robot 100 moves down an aisle of a retail store, the sensor 111 and the sensor 112 capture video data relating to inventory on shelves to the left and to the right of robot 100. The video data is stored in association with position information determined by the positioning system 101. Thus, for each video frame or for each group of video frames, a position within the retail environment is known and stored.

Another specific and non-limiting example of sensors 110 are Radio-Frequency identification (RFID) sensors 113 and 114. For example, RFID sensor 113 senses to the tell of the robot 100 while RFID sensor 114 senses to the right of the robot 100. As the robot 100 moves down an aisle of a retail store, RFID sensor 113 and the sensor 114 receive data transmitted by RFID tags attached to inventory, for example, clothing. Sensors 113 and 144 capture RFID tag data relating to inventory on racks to the left and to the right of robot 100. The RFID tag data is stored in association with position information determined by the positioning system 101. Thus, for each RFID tag or for each group of RFID tags, a position within the retail environment is known and stored. Alternatively, video data is also captured of the RFID tagged inventory that the RFID sensors detected. Thus video frames are associated with the RFID tag data and a position within the retail environment.

Further examples of sensors include 3D sensors, temperature sensors, light sensors, and so forth.

Referring to FIG. 2, shown is a robot 200 having a plurality of sensors thereon. The robot 200, has a positioning system 201 for determining its location within a building. The robot also has a plurality of sensors 210 for sensing its surroundings. For example, video camera 211 senses to the left of the robot 200 while video camera 212 senses to the right of the robot 200. As the robot 200 moves down an aisle of a retail store, the sensor 211 and the sensor 212 capture video data relating to inventory on shelves to the left and to the right of robot 200. The video data is stored in association with position information determined by the positioning system 201. Thus, for each video frame or for each group of video frames, a position within the retail environment is known and stored.

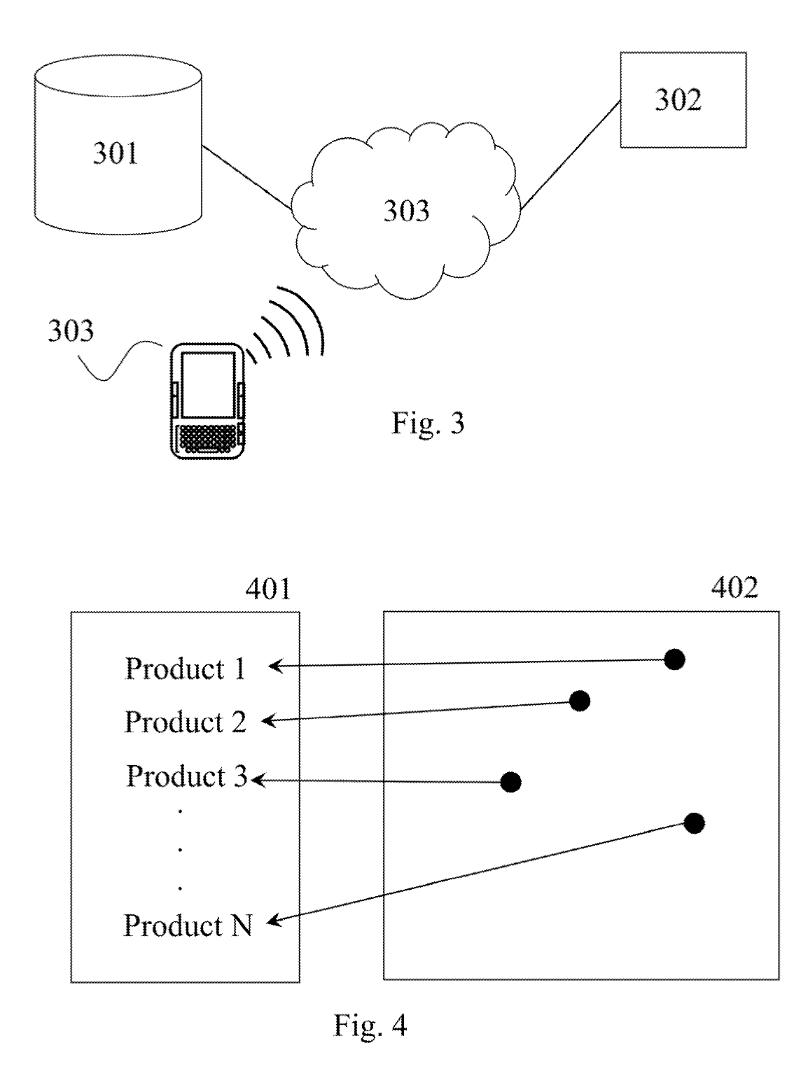

Referring to FIG. 3, shown is a simplified block diagram of a communication network. Devices with communication circuitry, for example, mobile communication device 300, server 301, and computer 302 communicate via network 303, for example, the Internet.

Referring to FIGS. 4-8, video data captured with cameras on a robotic device such as that of FIG. 1 or FIG. 2 is transmitted via a communication network such as that of FIG. 3 to a server. From the server, the video data is accessed for review by an inventory reviewer. The reviewer, for example, determines inventory that is missing from their position on the shelves. Alternatively, the reviewer notes any of a plurality of different issues within the retail environment including messes, damage, missing inventory, misplaced inventory, unsightly inventory situations, safety issues, and so forth.

Now referring specifically to FIG. 4, shown is a simplified diagram showing the interrelation between data, according to an embodiment. A product list 401 for a given retail establishment is stored electronically for access by the system. Typical product lists include product name, descriptions, skews, suppliers, and so forth. Store planogram 402 is stored for a given retail establishment. Planogram 402 associates products from the product list with locations for each product within a store. A planogram is a type of map for a store showing where each product is placed or should be placed. Video data captured by the robot 100, for example, is stored electronically and the position data allows for the video data to be correlated with the planogram. Thus, for each frame, an indication of the products that are likely in view is determinable. Further, data such as inventory levels is also typically maintained.

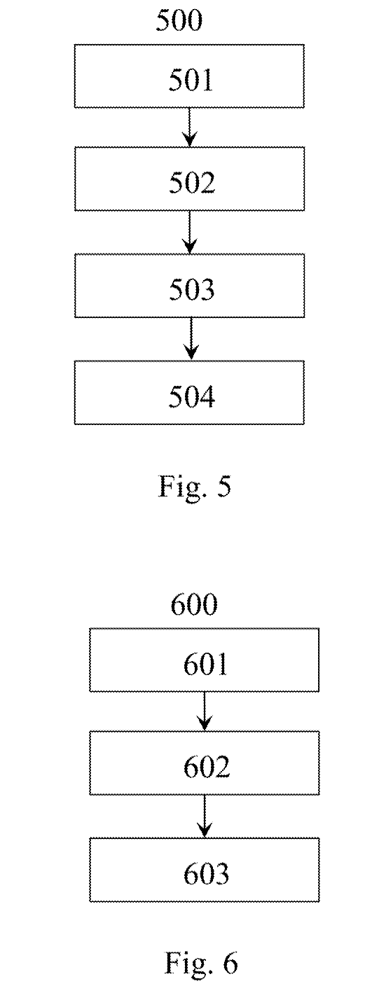

Referring to FIG. 5, shown is a simplified flow diagram 500 of a method of semi-automatically tracking inventory. At 501, the video data stored electronically is shown to an individual who highlights or selects empty shelf spaces at 502. These empty shelf spaces are correlated in the planogram with a product at 503 and, as such, the product identifier, the location, and optionally the frame are associated. Optionally, the data is stored together in a folder local to the store or for access by the store for reference by store staff at 504. Further optionally, the information is tabulated into as list or spreadsheet for easy review and access by store employees.

Referring to FIG. 6, shown is a simplified flow diagram 600 of the steps taken once empty shelf spaces are correlated in the planogram with as product. At 601, staff at the retail store, accesses the data to determine a list of action items to return the store to its “ideal” state. When the video frame is stored, staff optionally double check the reviewer's findings by looking at the specific empty space in the shelf image and determining if the product skew indicated as missing is correct in 602. Corrective action is then taken such that the deficiency is corrected at 603. Specific and non-limiting examples include, for a spill, clean up is initiated. For a missing item, the shelf is restocked. For a mess, the inventory is reorganized. For a product out of place, the product is retrieved for re-shelving. Furthermore, inventory that is missing from the shelf and out of stock in general is noted so that customers, store staff, and reviewers can be informed of this during their interactions with the store and the store data. Further an error in the product identifier for an empty space optionally results in updating the store planogram to maintain it fully up to date.

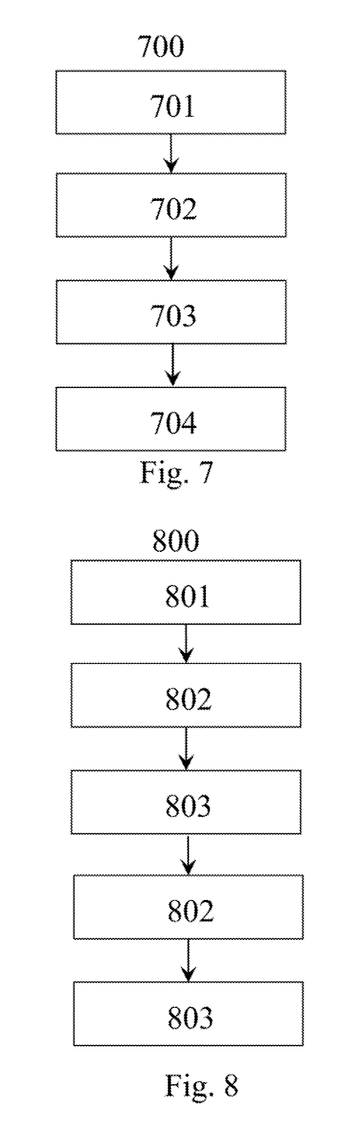

Now referring to FIG. 7, shown is a simplified flow diagram 700 of steps taken by an inventory reviewer. At 701, the inventory reviewer views video data captured with cameras on a robotic device such as that of FIG. 1 or FIG. 2. At 702, the inventory reviewer notices a condition on the video data that deems the retail store in other than an “ideal” state. The inventory reviewer notes the condition for alerting the retail store staff at 703. At 704, the inventory reviewer stores an indication of the condition in a data store. For example, the inventory reviewer selects a frame from the video that shows an empty space on a shelf a disorganized shelf, inventory that is placed in an incorrect location, a unsafe condition for the customers or the staff, suspicious customers, and so forth. Optionally, to highlight the condition on the video frame the inventory reviewer uses a software tool to circle or point to the exact spot on the video frame the condition of note.

Now referring to FIG. 8, shown is a simplified flow diagram 800 of steps taken by an inventory reviewer. At 801, the inventory reviewer views video data captured with cameras on a robotic device such as that of FIG. 1 or FIG. 2. At 802, the inventory reviewer notices a condition on the video data that deems the retail store in other than an “ideal” state. The inventory reviewer notes the condition for alerting the retail store staff at 803. At 804, the inventory reviewer stores an indication of the condition in a data store. For example. the inventory reviewer selects a frame from the video that shows an empty space on a shelf. Furthermore, the inventory reviewer has familiarity with the retail store environment and ideal location of products and thus at 805 adds text associated with the video frame selected. The inventory reviewer indicates the product that needs to be restocked on the shelf with empty space. This extra information aids in reducing the response time of retail store staff members to restock the shelf as the missing product is identified by the inventory reviewer and other than the retail store staff.

Examples of other conditions the inventory reviewer notes for alerting the retail store staff includes a disorganized shelf, inventory that is placed in an incorrect location, a unsafe condition for the customers or the staff, suspicious customers, and so forth. The inventory reviewer thus adds text associated with the video frame selected. Optionally, to highlight the condition on the video frame the inventory reviewer uses a software tool to circle or point to the exact spot on the video frame the condition of note.

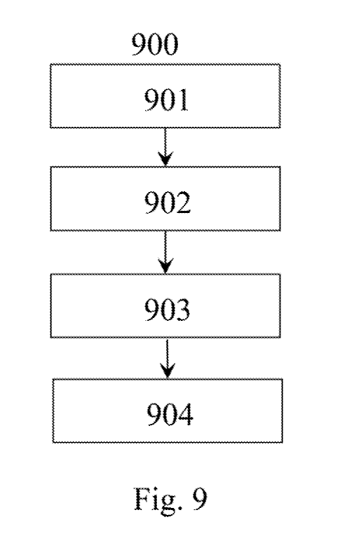

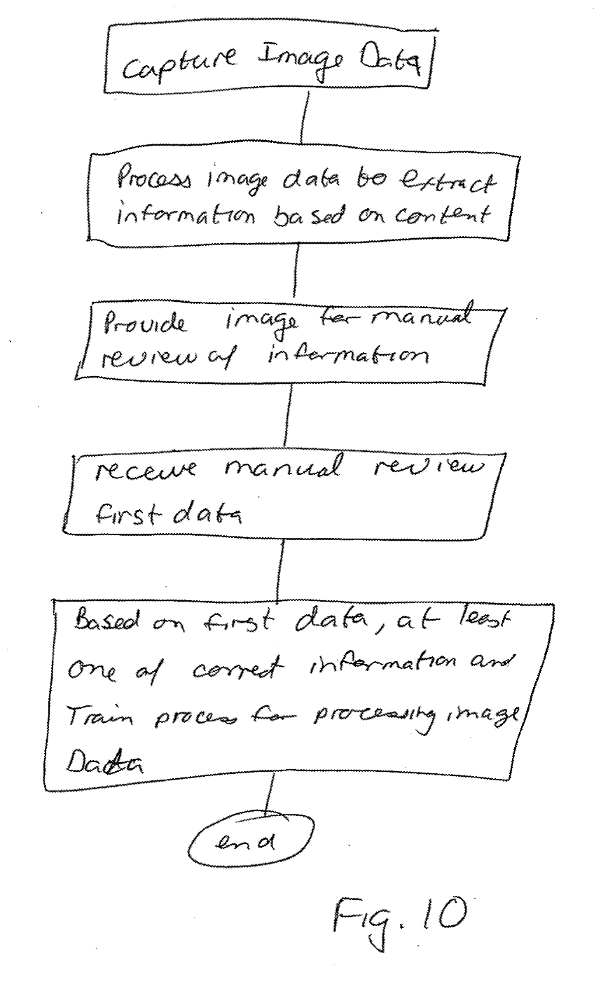

Referring now to FIG. 9, shown is a simplified flow diagram 900 for a method to recruit inventory reviewers and the inventory reviewers reviewing video data of a retail store taken with cameras on a robotic device such as that of FIG. 1 or FIG. 2. At 901, a retail store employs a brokering website to enable people and/or companies to place bids for reviewing the retail store's video. Such a website does not limit bidders to the locale of the retail store, in fact, the bidders could be located anywhere in the world provided they have access to the communication network to communicate with the retail store and receive video data. At 902, the retail store chooses the inventory reviewer based on the criteria of being the lowest bidder, however, other criteria could be used to make the selection such as reputation, reliability, etc. Alternatively, more than one bidder is selected to be inventory reviewers, as bidders may only be available to review the video for a specific time period and a plurality of reviewers are required to ensure video is reviewed for the time periods needed by the retail store. Once selected, the inventory reviewer is enabled by the retail store to access a server wherein the video data is stored at 903, and at 904 the inventory reviewer reviews the retail store's video to identify and indication less than “ideal” conditions of the retail store to staff members.

As will be evident to those of skill in the art, when the reviewer is at a remote location the sensor data in the form of video data is transmitted to them, either directly or via a server, and the results of their review is then transmitted hack to the store either directly or via a server. Typically, the two servers are the same, but this need not he so.

As the video review need not he performed in real-time, the server optionally provides an opportunity to pause video playback, speed it up, slow it down, etc. such that the reviewer or reviewers can hand off reviewing tasks mid task or can take breaks and pick up where they left off.

In another embodiment, each reviewer result is used as a training instance for an automation system. As the confidence of the automation system improves, the automation system highlights problems and labels them automatically for confirmation by the reviewer. Thus, the review process is facilitated and the overall review is potentially improved. For example, a bolt is missing from the fixtures leading to a safety concern. After the 80^{th} instance, the system begins to automatically highlight missing bolts within image frames for reviewer confirmation. Thus, physically small problems are accurately and repeatedly highlighted after a training period.

In another embodiment, each reviewer result is used as a training instance for an automation system. As the confidence of the automation system improves, the automation system highlights problems and labels them automatically. Thus, problems are automatically, accurately and repeatedly highlighted after a training period.

Advantageously, the training is store specific so differences in lighting, and other differences from venue to venue are accounted for. Alternatively, the training is applied globally to the system. When the training is globally applied, video analytics optionally filters out discrepancies. Alternatively, video analytics accounts for differences. Further alternatively, training methodologies account for discrepancies and provide training that functions adequately in the face of slight or significant variations.

Another advantage to the training methodology proposed is that the system is trained during normal operation allowing for training costs to be kept very low since the work is actual work that is being done. Further, even when some problems are difficult or impossible to identify reliably, the system provides the video data to a reviewer for manual review, and as such, works on all problems even when only some are automatically identified.

In yet another embodiment, a reviewer controls a robot using telepresence processes to walk the robot through a venue and note deficiencies. Such system advantageously allows for additional inspection of problems through robot manipulation and provides the inherent safety of a human operator when used during high traffic times at a given venue. In such a system the video data is optionally reviewed live as opposed to from previously stored video data.

As noted above, an automated deficiency extraction process is trainable with data collected from a manual review. Such an automated deficiency detection process is also improvable through a similar approach. In such an instance, as shown in FIG. 10, image data is captured and processed to extract content therefrom. For example, content is item labels labeling items on shelves or works of art on a wall. Alternatively, content is indicative of state such as facing of items on shelves. Further alternatively, content is indicative of deficiencies. For some images and content, image data is provided for a manual review as discussed hereinabove to verify the content. For example, when the content extraction process is uncertain of its result. Alternatively, images are selected at random for verification. Further alternatively, they are selected in accordance with a costing model where a cost of an error is used to determine if further review is desirable. Yet further alternatively, images are selected at intervals. When a reviewer notes an error in the content, the content is updated and the updated result is used fur further training. Alternatively, a group of updated results are determined and training is performed in a batch mode. Further alternatively, the content is updated but no further training is undertaken. Yet further alternatively, an employee or another person is dispatched to verify the content in situ within the venue where the image was captured.

Of note, verification that content is correct is also helpful fur further training of the automated process.

Numerous other embodiments may be envisaged without departing from the spirit or scope of the invention.

What is claimed is:

1. A method comprising:
moving a telepresence device within the location, the telepresence device controlled by a remote operator;
capturing images with the telepresence device and providing first image data via a communication network to the remote operator of the telepresence device;
receiving from the remote operator first data indicative of content within an image; and
storing content data based on the first data and the image within a geospatial database based on at least one of a location of the telepresence device and a location of the telepresence device when it captured the image, the data for annotating a geospatial database correlated with image content.

2. A method according to claim 1, further comprising transmitting a notification to a destination based on the first data, a content of the notification based on the first data and indicative of an expected response to the content.

3. A method according to claim 2 wherein the notification comprises the image comprising further information therein.

4. A method according to claim 1, further comprising:
receiving from the remote operator second data indicative of content within another image; and
transmitting a notification to a destination based on the first data and the second data, a content of the notification based on the first data and the second data.

5. A method according to claim 1 wherein the image data comprises label information determined automatically by processing the image.

6. A method according to claim 5 wherein the first data is for correcting the label information.

7. A method according to claim 1 wherein the first data is for indicating a deficiency requiring attention, the first data indicative of the deficiency location within the image.

8. A method comprising:
providing a geospatial dataset relating to a location, the dataset including data relating to features of locals within. the location;
moving a telepresence device within the location, the telepresence device controlled by a remote operator;
capturing images with the telepresence device and providing first image data via a communication network to the remote operator of the telepresence device, the first image data relating to at least some of the features;
receiving from the remote operator first data indicative of content within an image; and
storing content data based on the first data and the image within a geospatial database based on at least one of a location of the telepresence device and a location of the telepresence device when it captured the image, the data for annotating the geospatial data set.

9. A method according to claim 8, further comprising transmitting a notification to a destination based on the first data, a content of the notification based on the first data and indicative of an expected response to the content.

10. A method according to claim 9, wherein the notification comprises the image comprising data based on the first data added thereto.

11. A method according to claim 8, further comprising:
receiving from the remote operator second data indicative of content within another image; and
transmitting a notification to a destination based on the first data and the second data, a content of the notification based on the first data and the second data.

12. A method according to claim 8, wherein the image data comprises label information determined automatically by processing the image superimposed therein.

13. A method according to claim 12, wherein the first data is for correcting the label information.

14. A method according to claim 13, wherein processing is performed by a trainable process and wherein the first data is provided as training data for further training of the trainable process.

15. A method according to claim 8, wherein the image data comprises label information retrieved from the geospatial dataset and superimposed therein.

16. A method according to claim 15, wherein the first data is for correcting the label information within the geospatial dataset.

17. A method according to claim 8, further comprising displaying for the operator an image captured by the telepresence device and a geographical display image of a same location.

18. A method according to claim 8 comprising: displaying for the operator an image captured by the telepresence device overlaid, with data from the geospatial dataset.

19. A telepresence operator system comprising:
a communication circuit for receiving from a telepresence device an image captured by the telepresence device, tor transmitting to the telepresence device control signals for controlling movement of the telepresence device and for transmitting to the telepresence device audio-video signals for displaying thereon video data from the operator and for outputting therefrom sound sensed at the telepresence operator system;
a display for displaying the image and for displaying data from a geospatial dataset within the image; and
a transducer for receiving user input information relating to at least one of errors in the geospatial dataset and problems with items displayed within the image and for providing the user input information to the communication circuit for transmitting same for updating the geospatial dataset.

20. A method comprising:
operating a telepresence system from an telepresence operator system for supporting two way audio-video communication with a remote telepresence device and for supporting remote control of movement of the telepresence device;
receiving from the telepresence device video data for use in audio-video communication;
displaying the video data on the telepresence operator system;
receiving at the telepresence operator system user input data relating to a content of features displayed within the video; and
providing the user input data via a communication network for updating a geospatial dataset.

21. A method comprising:
operating a telepresence system from an telepresence operator system tor supporting two way audio-video communication with a remote telepresence device and for supporting remote control of movement of the telepresence device;
receiving from the telepresence device video data for use in audio-video communication;
displaying the video data on the telepresence operator system;
receiving at the telepresence operator system user input data relating to a content of features displayed within the video; and
providing the user input data via a communication network for updating a list of tasks to he performed at a location of the telepresence device and relating to the features displayed.
